(19) United States
(12) Patent Application Publication
(10) Pub. No.: US 2011/0161686 A1
(43) Pub. Date: Jun. 30, 2011

(54) POWER SUPPLY CONTROL MODULE, ELECTRONIC DEVICE, AND RESET CONTROL METHOD

(76) Inventor: Takeshi Kumagaya, Hachioji-shi (JP)

(21) Appl. No.: 12/868,536

(22) Filed: Aug. 25, 2010

(30) Foreign Application Priority Data
Dec. 24, 2009 (JP) 2009-293303

(51) Int. Cl. G06F 1/26

(52) U.S. Cl. 713/300

(57) ABSTRACT

According , one embodiment, a power supply control module includes: a memory module; power supply controller; a voltage determination module; and reset execution module. The power supply controller performs supply/cutoff control of a voltage from a main power supply to a load via a power supply circuit by performing ON/OFF control of a switch module. The voltage determination module determines whether, during a standby state operating on a voltage supplied from a charge accumulating module, a value of the voltage supplied from the charge accumulating module is equal to or smaller than a reset threshold value set in advance. The reset execution module performs a reset execution operation for clearing a status retained in a memory module, the voltage determination module determines that the value of the voltage is equal to or smaller than the reset threshold value.

### CROSS-REFERENCE TO RELATED APPLICATIONS

This application is based upon and claims the benefit of priority from Japanese Patent Application No. 2009-293303, filed Dec. 24, 2009, the entire contents of which are incorporated herein by reference.

### FIELD

Embodiments described herein relate generally to a technology of reset control implemented in a power supply control module.

### BACKGROUND

Typically, there is known electronic devices such as a television receiver performing, with a voltage supplied from a storage battery functioning as a standby power supply during a standby state, awaiting operation in order to wait for an input of a power ON/OFF control signal. Among the electronic devices, many of them comprises a power supply control circuit (power supply control module) performing power supply control in which a voltage from a main power supply (from a commercial power supply such as a household outlet) is supplied to the loads in the electronic device via a power supply circuit, upon receiving a power ON control signal.

In recent years, with an aim to reduce the voltage consumption during the standby state of the power supply circuit connected to the main power supply; there has been developed an electronic device comprising a switch module. The switch module is composed of a restoration switch, a latching relay, and the like, and is disposed in between the main power supply and the power supply circuit.

During the standby state in the power supply control circuit of such an electronic device, the switch module is turned OFF and operations in the standby state are performed using the voltage supplied from the storage battery. Subsequently, when a power ON signal is received from the remote control or when a signal is received'r ma timer at a programmed recording timing or when the voltage in the storage battery drops to a lower level; the switch module is turned ON and the voltage from the main power supply is supplied to the loads (e.g., storage battery, microcomputer, image display module) in the electronic device via the power supply circuit.

Meanwhile, consider a case when a power-on reset method that is implemented in a commonly-used large-scale integration (LSI) circuit is implemented as a reset method for clearing the status retained by a status retaining module that is disposed in the power supply control circuit of abovementioned type. In that case, in the electronic device comprising the abovementioned power supply control circuit, every time the switch module of the power supply control circuit is turned ON as a result of (a) connecting the switch module to the main power supply via a plug when the storage battery is in a fully discharge state, (b) receiving a power ON signal from the remote control, or (c) receiving a signal from a timer at a programmed recording timing or as a result of a drop in the voltage level in the storage battery; a reset signal is sent to the status retaining module disposed in he power supply control circuit. Consequently, the status retained up to that point of time gets cleared from the status retaining module.

Herein, the status represents the state information of the power supply control circuit. For example, the status can represent information about a trigger for turning ON the latching relay. More particularly, the status can represent information about the fact that reception of a power ON signal from the remote control had functioned as a trigger for turning ON the latching relay. Further, the status can represent information about the fact that reception of a signal from a timer at a programmed recording timing had functioned as a trigger for turning ON the latching relay. Still further, the status can represent information about the fact that a drop in the voltage level in the storage battery had functioned as a trigger for turning ON the latching relay.

In the abovementioned electronic device, the microcomputer (i.e., a higher-level control module in the power supply control circuit) in the electronic device performs operation control based on the status retained by the power supply control circuit. Hence, if the status retained by the power supply control circuit gets cleared every time a relay module is turned ON as described above, then there is a possibility that the microcomputer cannot recognize the operation control to be subsequently performed.

More particularly, for example, assume that the retained status represents information about the fact that reception of a signal from a timer at a programmed recording timing had functioned as a trigger for turning ON the latching relay. In that case, the microcomputer is able to recognize that the recording operation is to be subsequently performed. However, in case the status gets cleared in the abovementioned manner, then there is a possibility that the microcomputer cannot recognize the subsequent operation and thus cannot proceed further.

Thus, in the conventional power supply control circuit, if the power-on reset method that is implemented in a commonly-used LSI circuit is implemented in the power supply control circuit; then the status retained by a status retaining module gets cleared every time the relay module is turned ON. As a result, there arises a possibility that the microcomputer (higher-level control module) cannot perform status-based operation control (e.g., programmed recording).

In view of the above, the inventor(s) of the present invention considered the following policy to be expedient. According to that policy, on the one hand, the power supply control circuit is reset only if the voltage supplied thereto as a result of connecting the switch module to the main power supply via a plug in the fully discharge state of the storage battery or as a result of removing the plug so that the switch module gets disconnected from the main power supply and the storage battery falls in the fully discharge state is outside a range of operation guaranteeing voltage values. On the other hand, as long as the voltage supplied to the power supply control circuit (power supply controller) is within the range of operation guaranteeing voltage values, the status of the power supply control circuit is retained.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not limit the scope of the invention.

FIG. 1 is an exemplary block diagram of a configuration of the television system and a functional configuration of a television receiver according to an embodiment;

FIG. 2 is an exemplary block diagram of a functional configuration of a power supply control circuit in the embodiment;

FIGS. 3A to 3C are exemplary explanatory diagrams of a specification example of the operating voltages of the power supply control circuit and setting examples of different threshold values in the embodiment;

FIG. 4 is an exemplary flowchart for explaining the sequence in a reset operation during an initial state in the embodiment;

FIG. 5 is an exemplary flowchart for explaining the detailed sequence in the reset operation performed at S14 in FIG. 4 in the embodiment;

FIG. 6 is an exemplary flowchart for explaining the sequence in a reset operation during a standby state in the embodiment;

and

FIG. 7 is an exemplary flowchart for explaining the sequence in a latching relay ON/OFF operation performed in a power supply control module in the embodiment.

### DETAILED DESCRIPTION

In general, according to on embodiment, a power supply control module comprises: a memory module; a power supply controller, a voltage determination module; and a reset execution module. The memory module is configured to retain a status that represents state information of the power supply control module. The power supply controller is configured to perform supply/cutoff control of a voltage from a main power supply to a load via a power supply circuit by performing ON/OFF control of a switch module that is disposed in between the main power supply and the power supply circuit. The voltage determination module is configured to determine whether, during a standby state operating on a voltage supplied from a charge accumulating module , a value the voltage supplied from the charge accumulating module is equal to or smaller than a reset threshold value set in advance. The reset execution module is configured to perform a reset execution operation for clearing the status retained in the memory module, if the voltage determination module determines that the value of the voltage is equal to or smaller than the reset threshold value.

According to another embodiment, an electronic device comprising a power supply control module. The power supply control module comprises: a memory module; a power supply controller; a voltage determination module; and a reset execution module. The memory module is configured to retain a status that represents state information of the power supply control module. The power supply controller configured to perform supply/cutoff control of a voltage from a main power supply to a load via a power supply circuit by performing ON/OFF control of a switch module that is disposed in between the main power supply and the power supply circuit. The voltage determination module configured to determine whether, during a standby state operating on a voltage supplied from a charge accumulating module, a value of the voltage supplied from the charge accumulating module is equal to or smaller than a reset threshold value set in advance. The reset execution module configured to perform a reset execution operation for clearing the status retained in the memory module, if the voltage determination module determines who the value of the voltage is equal to or smaller than the reset threshold value.

According to still another embodiment, a reset control method performed in a power supply control module configured u perform supply/cutoff control of a voltage from a main power supply to a load via a power supply circuit by performing ON/OFF control of a switch module that is disposed in between the main power supply and the power supply circuit, the reset control method comprises: first-determining, by a voltage determination module, that includes determining whether, during a standby state operating on a voltage supplied from a charge accumulating module, a value of the voltage supplied from the charge accumulating module is equal to or smaller than a reset threshold value set in advance; and first-reset-controlling, by a reset execution module, that includes performing a reset execution operation for clearing the status retained in a memory module, if the value of the voltage is determined to be equal to or smaller than the reset threshold value at the first-determining.

Various embodiments will be described hereinafter with reference to the accompanying drawings.

The embodiments are explained in terms of a power supply control module that, by performing ON/OFF control of a switch module disposed between a main power supply and a power supply circuit, performs supply/cutoff control of the voltage from the main power supply to each load via the power supply circuit; in terms of an electronic device that comprises the power supply control module; and in terms of a reset control method implemented in the power supply control module. The descriptions of the following embodiments are given with respect to a television system.

Firstly, explained below are various configurations in the television system with respect to which the embodiments are explained.

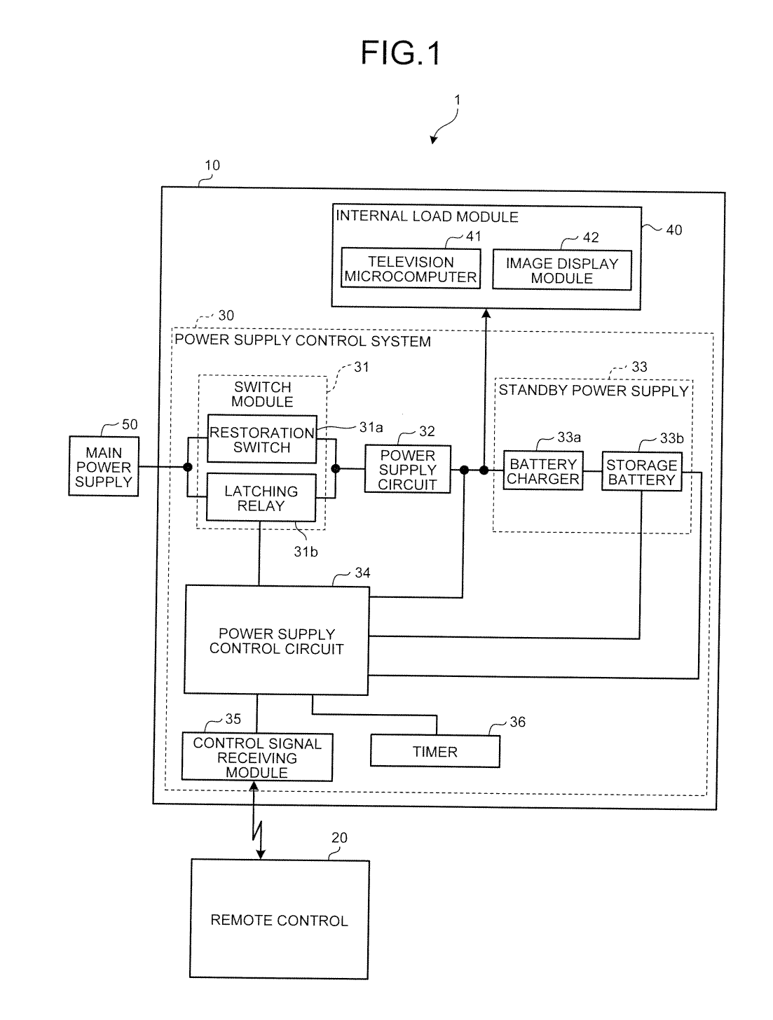

FIG. 1 is an exemplary block diagram of a configuration of the television system and a functional configuration of a television receiver according to an embodiment.

As illustrated in FIG. 1, a television system I mainly comprises a television receiver 10, which reproduces images based on signals received via radio waves or via a cable, and a remote control 20, which is used for operating the television receiver 10 from a distance.

The television receiver 10 according to the present embodiment mainly comprises a power supply control system 30 and an internal load module 40.

During a standby state that includes no image reproduction on the liquid crystal panel of an image display module 42 (described later), or includes a wait for a power ON/OFF signal from the remote control 20, or includes a wait for a signal from a timer 36; the power supply control system 30 performs operations in the standby state using a voltage supplied from a storage battery 33b (described later) functioning as a standby power supply.

The power supply control system 30 according to the present embodiment comprises a switch module 31, a power supply circuit 32, a standby power supply 33, a power supply control circuit (power supply control module) 34, a control signal receiving module 35, and the timer 36.

The switch module 31 comprises a restoration switch 31a and a latching relay 31b that are connected in parallel in between a main power supply (commercial power supply through household outlets) 50 and the power supply circuit 32.

To the switch module 31 is connected a cord of an insertion tool such as a plug. By inserting the plug into a household outlet (main power supply 50) , the voltage from the main power supply 50 is supplied to the power supply circuit 32, that is, supplied to the loads in the television receiver 10 via the switch module 31.

In the fully discharge state of the storage battery 33b and in an OFF state of the latching relay 31b (e.g., when the latching relay 31b enters the OFF state due to vibrations encountered during the shipment of the television receiver 10 to the buyer's house), if the switch module is connected to the main power supply 50; then the restoration switch 31a ensures that the voltage from the main power supply 50 is supplied to the power supply circuit 32, that is, supplied to each load.

The latching relay 31b is relay module in which a switch is turned ON and OFF by the ON/OFF control performed by the power supply control circuit 34.

The power supply circuit 32 steps up/steps down the voltage from the main power supply 50, performs voltage rectification and voltage smoothing, and then outputs direct-current (DC) voltage that is then supplied to the internal circuits of the television receiver 10.

The standby power supply 33 supplies a voltage during the standby state of the power supply control system 30 and comprises, for example, a battery charger 33a and the storage battery 33b.

The battery charger 33a is a charging module that charges the storage battery 33b, which is a charge accumulating module such as a secondary battery for accumulating electrical charge.

The power supply control circuit 34 performs ON/OFF control of the latching relay 31b disposed in between the main power supply 50 and the power supply circuit 32 in order to perform supply/cutoff control of the voltage from the main power supply 50 to the loads (e.g., the standby power supply 33 and the internal load module 40) via the power supply circuit 32. Besides, in the present embodiment, the power supply control circuit 34 also performs a reset control method described later.

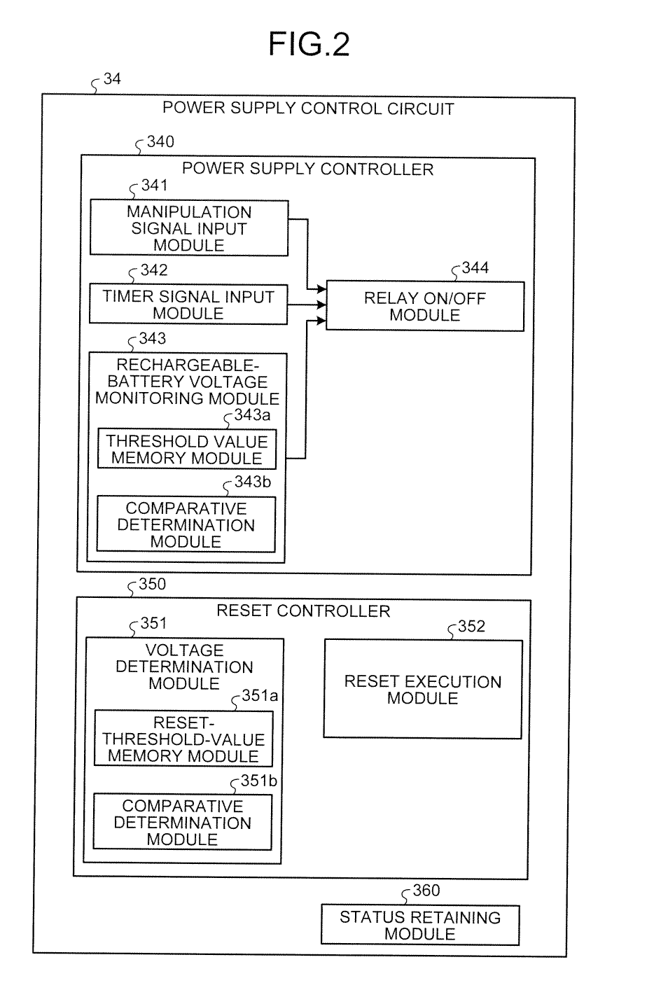

FIG. 2 is an exemplary block diagram of a functional configuration of the power supply control circuit 34.

As illustrated in FIG. 2, the power supply control circuit 34 mainly comprises a power supply control module 340, a reset controller 350, and a status retaining module 360.

The power supply controller 340 comprises a manipulation signal input module 341, a timer signal input module 342, a rechargeable-battery voltage monitoring module 343, and a relay ON/OFF module 344.

When a power ON signal is received from the remote control 20, the manipulation signal input module 341 outputs to the relay ON/OFF module 344 an ON signal as a relay ON instruction. Besides, when a power OFF signal is received from the remote control 20, the manipulation signal input module 341 passes that power OFF signal to a television microcomputer 41.

When a power ON signal is received from the timer 36, the timer signal input module 342 outputs to the relay ON/OFF module 344 an ON signal as a relay ON instruction. Besides, when a power OFF signal is received from the timer 36, the timer signal input module 342 passes that power OFF signal to the television microcomputer 41.

Upon receiving the power OFF signal, the television microcomputer 41 determines the current state and, based on the determination result, outputs to the power supply control circuit 34 a power OFF command as a relay ON instruction to the relay ON/OFF module 344. For example, upon receiving the power OFF signal, if programmed recording Is to be performed; then the television microcomputer 41 sets the start-up time thereof in the power supply control circuit 34 and outputs the power OFF command to the power supply control circuit 34. Consequently, in the power supply control circuit 34, the relay ON/OFF module 344 turns OFF the switch of the latching relay 31b. Besides, the power supply control circuit 34 can also instruct the timer 36 to perform a timekeeping operation with respect to the start-up time.

The rechargeable-battery voltage monitoring module 343 monitors the value of the voltage supplied from the storage battery 33b during the standby state of the power supply control system 30. If the voltage supplied from the storage battery 33b becomes equal to or smaller than (or drops below) a predetermined recharge threshold value, then the rechargeable-battery voltage monitoring module 343 sends a relay ON instruction to the relay ON/OFF module 344 for the purpose of recharging the storage battery 33b. On the other hand, if the voltage supplied from the storage battery 33b becomes equal to or greater than (or exceeds) a predetermined recharge cancel threshold value, the rechargeable-battery voltage monitoring module 343 sends a relay OFF instruction to the relay ON/OFF module 344 for the purpose of stopping the recharging of the storage battery 33b. In the present embodiment, the rechargeable-battery voltage monitoring module 343 comprises a threshold value memory module 343a and a comparative determination module 343b.

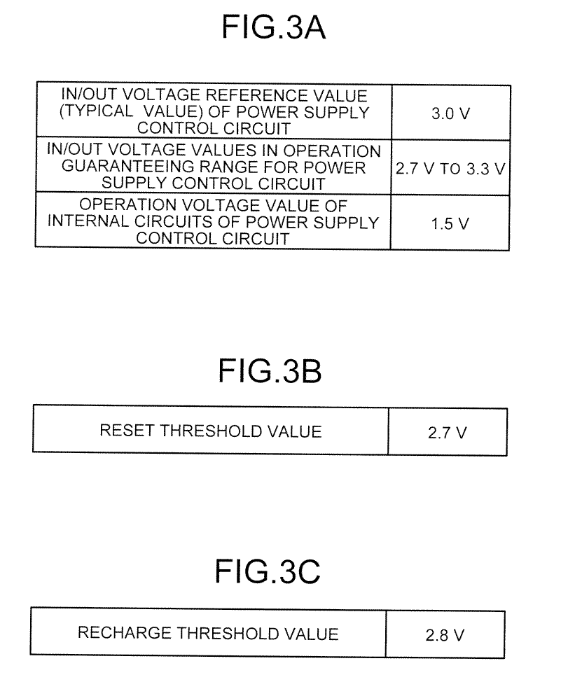

More particularly, during the standby state of the power supply control system. 30, the comparative determination module 343b in the rechargeable-battery voltage monitoring module 343 determines whether the value of the voltage supplied to the power supply control circuit 34 has become equal to or smaller than (or dropped below) the recharge threshold value (2.8 V in FIG. 3C) stored in the threshold value memory module 343a. If it is determined that the value of the voltage supplied to the power supply control circuit 34 has become equal to or smaller than (or dropped below) the recharge threshold value, then the rechargeable-battery voltage monitoring module 343 outputs to the relay ON/OFF module 344 an ON signal as a relay ON instruction.

Besides, during the standby state of the power supply control system 30 and after the relay ON/OFF module 344 turns ON the switch of the latching relay 31b, the comparative determination module 343b in the rechargeable-battery voltage monitoring module 343 determines whether the value of the voltage being supplied to the power supply control circuit 34 has become equal to or greater than (or exceeded) the recharge cancel threshold value stored in the threshold value memory module 343a (not illustrated). If it is determined that the value of the voltage being supplied to the power supply control circuit 34 has become equal to or greater than (or exceeded) the recharge cancel threshold value, then the rechargeable-battery voltage monitoring module 343 outputs to the relay ON/OFF module 344 an OFF signal as a relay OFF instruction.

Thus, upon receiving an ON signal from either one of the manipulation signal input module 341, the timer signal input module 342, and the rechargeable-battery voltage monitoring module 343; the relay ON/OFF module 344 turns ON the switch of the latching relay 31b. On the other hand, upon receiving a power OFF command from the television microcomputer 41 or upon receiving an OFF signal from the rechargeable-battery voltage monitoring module 343; the relay ON/OFF module 344 turns OFF the switch of the latching relay 31b.

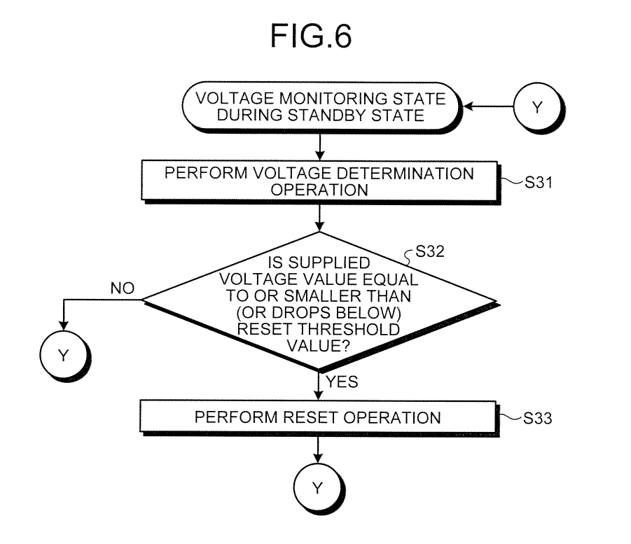

The reset controller 350 performs a reset operation during an initial state as described later with reference to FIG. 5 and also performs a reset operation during the standby state as described later with reference to FIG. 6. In the present embodiment, the reset controller 350 comprises a voltage determination module 351 and a reset execution module 352.

During the fully discharge state of the storage battery 33b, when the switch module 31 is connected to the main power supply 50 and when the restoration switch 31a is pressed and when the voltage is supplied to the loads (e.g., the standby power supply 33 and the internal load module 40) via the power supply circuit 32 (i.e., during the initial state); the voltage determination module 351 monitors the value of the voltage supplied to the power supply control circuit 34 (supplied voltage value). Besides, during the standby state of the power supply control system 30, the voltage determination module 351 monitors the value of the voltage supplied from the storage battery 33b (supplied voltage value). Herein, the voltage determination module 351 comprises a reset-threshold-value memory module 351a and a comparative determination module 351b.

More particularly, during the initial state, the comparative determination module 351b in the voltage determination module 351 determines whether the supplied voltage value has become equal to or greater than (or exceeded) the reset threshold value (2.7 V in FIG. 3B) stored in the reset-threshold-value memory module 351a. If it is determined that the supplied voltage value has become equal to or greater than (or exceeded) the reset threshold value, then the comparative determination module 351b outputs to the reset execution module 352 an execution signal as a reset execution instruction.

Besides, during the initial state, the comparative determination module 351b in the voltage determination module 351 determines whether the supplied voltage value has become equal to or smaller than (or dropped below) the reset threshold value (2.7 V in the example in FIG. 3B) stored in the reset-threshold-value memory module 351a. if it is determined that the supplied voltage value has become equal to or smaller than (or dropped below) the reset threshold value, then the comparative determination module 351b outputs to the reset execution module 352 a signal as a reset execution instruction.

If the reset execution module 352 receives an execution signal from the voltage determination module 351 during the initial state or during the standby state, it clears the status retained by toe status retaining module 360 disposed in the power supply control circuit 34.

Meanwhile, the power supply control circuit 34 according to the present embodiment is implemented using a chip on which electronic circuits such as integrated circuits (IC) or LSI circuits are integrated.

FIGS. 3A to 3C are explanatory diagrams of a specification example of the operating voltages of the power supply control circuit 34 and setting examples of different threshold values. More particularly, FIG. 3A illustrates a specification example of the operating voltages of the power supply control circuit 34; FIG. 3B illustrates a setting example of the reset threshold value; and FIG. 3C illustrates a setting example of the recharge threshold value.

As illustrated in case in FIG. 3A, the voltage value of 3.0 V is optimum for the power supply control circuit 34 to perform operations in a normal manner. Moreover, the voltage values in the range of 2.7 V to 3.3 V represent operation guaranteeing voltage values. Furthermore, the internal circuits of the power supply control circuit 34 have the operation voltage value of 1.5 V.

As illustrated in case in FIG. 3B, the reset threshold value of 2.7 V is stored in the reset-threshold-value memory module 351a. Thus, the reset threshold value is equal to the minimum voltage value of 2.7 V in the range of operation guaranteeing voltage values. Hence, the reset operation during the initial state can cc performed after the power supply control circuit 34 enters an operable state. Similarly, the reset operation during the standby state can be performed when a voltage outside the range of operation guaranteeing voltage values is nearly supplied to the power supply control circuit 34.

As illustrated in case in FIG. 3C, the recharge threshold value of 2.8 V is stored in the threshold value memory module 343a. Thus, the recharge threshold value slightly exceeds the minimum voltage value of 2.7 V in the range of operation guaranteeing voltage values. Hence, the storage battery 33b can be recharged when it nearly supplies a voltage outside the range of operation guaranteeing voltage values to the power supply control circuit 34.

Returning to the explanation with reference to FIG. 1, the control signal receiving module 35 receives, from the remote control 20, various control signals as instructions, for example, for turning ON the power, selecting a channel, and selecting the volume.

The timer 36 is a timekeeping module that outputs a signal after the elapse of a programmed recording period, an automatic power ON period, or an automatic power OFF period.

The internal load module 40 represents a load module disposed other than in the power supply control system 30 and comprises, for example, the television microcomputer 41 and the image display module 42 of the television receiver 10 that are equivalent to the load modules in a commonly-used television receiver.

Explained below are various operations performed in the television system 1.

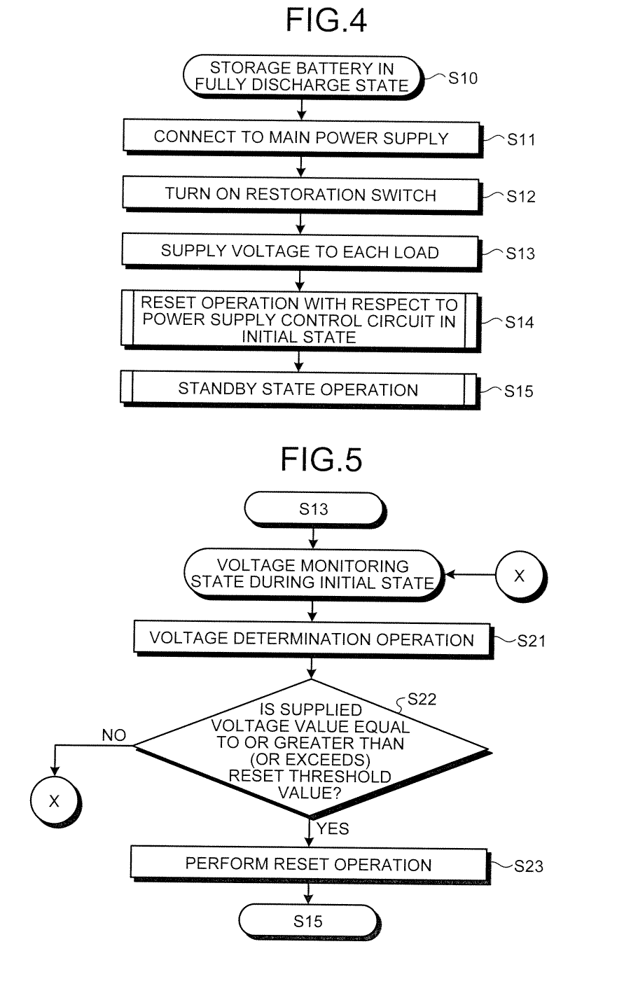

FIG. 4 is an exemplary flowchart for explaining the sequence in the reset operation during the initial state.

As illustrated in FIG. 4, in the fully discharge state of the storage battery 33b at the time of delivery of the television system 1 to the buyer's house or in the fully discharge state of the storage battery 33b as a result of keeping the plug of the already-delivered television receiver 10 removed from the main power supply C for a prolonged time (S10), the operator such as the buyer connects The plug to the main power supply 50 (S11) and presses the restoration switch 31a (512). Consequently, the voltage from the main power supply 50 is supplied to the loads (e.g., the standby power supply 33 and the internal load module 40) of the television receiver 10 via the power supply circuit 32 (S13).

Subsequently, the reset controller 350 performs a reset operation with respect to he power supply control circuit 34 in the initial state (S14).

FIG. 5 is an exemplary flowchart for explaining the detailed sequence in the reset operation performed at S14.

As illustrated in FIG. 5, during a voltage monitoring state during the initial state, the comparative determination module 351b in the voltage determination module 351 performs a voltage determination operation (S21 and S22).

More particularly, the comparative determination module 351b determines whether the value of the voltage supplied to the power supply control circuit 34 (supplied voltage value) is equal to or greater than (or exceeds) the reset threshold value of 2.7 V (S21).

If it is determined that the supplied voltage value is equal to or greater than (or exceeds) the reset threshold value (Yes at S22), then the comparative determination module 351b outputs to the reset execution module 352 an execution signal as a reset execution instruction.

Upon receiving the execution signal, the reset execution module 352 performs the reset operation (S23). That is, the reset execution module 352 sends a reset signal to the internal circuits of the power supply control circuit 34 so that the status retained by the internal circuits gets cleared.

Subsequently, returning to the description with reference to FIG. 4, the operations in the standby state of the power supply control system 30 are performed in the power supply control circuit 34 (S15).

FIG. 6 is an exemplary flowchart for explaining the sequence in the reset operation during the standby state.

As illustrated in FIG. 6, during a voltage monitoring state during the standby state, the comparative determination module 351b in the voltage determination module 351 performs a voltage determination operation (S31 and S32).

More particularly, the comparative determination module 351b determines whether the value of the voltage supplied to the power supply control circuit 34 (supplied voltage value) is equal to or smaller than (or drops below) the reset threshold value of 2.7 V (S31).

If it is determined that the supplied voltage value is equal to or smaller than (or drops below) the reset threshold value (Yes at S32) , then the comparative determination module 351b outputs to the reset execution module 352 an execution signal as a reset execution instruction.

Upon receiving the execution signal, the reset execution module 352 performs the reset operation (S33). That is, the reset execution module 352 sends a reset signal to the status retaining module 360 so that the status retained by the status retaining module 360 gets cleared.

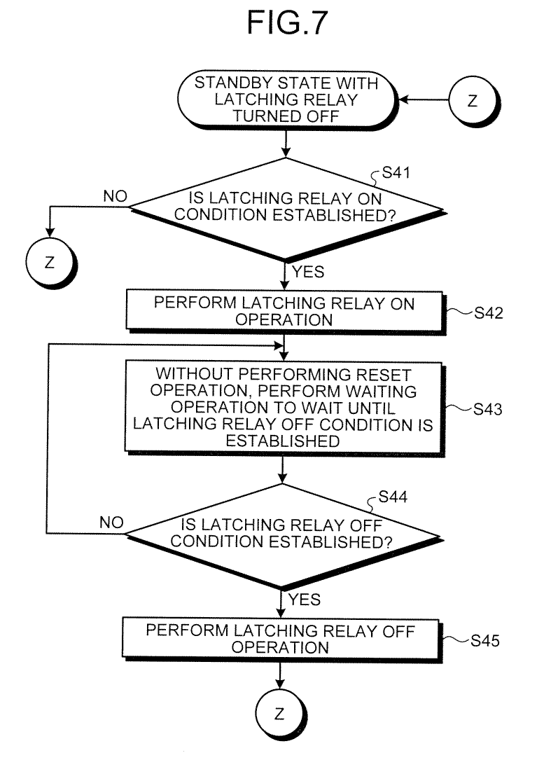

FIG. 7 is an exemplary flowchart for explaining the sequence in a latching relay ON/OFF operation performed in the power supply controller 340.

As illustrated in FIG. 7, in a latching relay OFF state during the standby state, the relay ON/OFF module 344 performs a waiting operation in order to wait for the input of an ON signal as a relay ON instruction from either one of the manipulation signal input module 341, the timer signal input module 342, and the rechargeable-battery voltage monitoring module 343 (S41). When an ON signal is received during the waiting operation (Yes at S41), the relay ON/OFF module 344 turns ON the switch of the latching relay 31b (S42).

Subsequently, without performing the reset operation of clearing the status retained by the internal circuits, power supply control circuit 34 performs a waiting operation in order to wait until a let thing relay OFF condition is established by the relay ON/OFF module 344. That is, the power supply control circuit 34 performs a waiting operation in order to wait for the input of a power OFF command or an OFF signal as a relay OFF instruction of the latching relay 31b from the television microcomputer 41 or the rechargeable-battery voltage monitoring module 343 (S43 and S44)

When the latching relay OFF condition is established during the waiting operation, that is, when an OFF signal is received from either one of the manipulation signal input module 341, the timer signal input module 342, and the rechargeable-battery voltage monitoring module 343 (Yes at S44) the relay ON/OFF module 344 turns OFF the switch of the latching relay 31b (S45)

In this way, according to the abovementioned embodiment, the reset operation is performed with respect to the power supply control circuit 34 only if the voltage supplied thereto as a result of connecting the switch module 31 to the main power supply 50 in the fully discharge state of the storage battery 33b or as a result of disconnecting the switch module 31 from the main power supply 50 so that the storage battery 33b falls in the fully discharge state is outside a range of operation guaranteeing voltage values. Hence, as long as the voltage supplied to the power supply control circuit 34 is within the range of operation guaranteeing voltage values, the reset operation is not performed with respect to the power supply control circuit 34 irrespective of whether the latching relay 31b in the switch module 31 is turned ON. That enables the status retaining module 360 in the power supply control circuit 34 to retain the status of the power supply control circuit 34 on a constant basis.

For that reason, it becomes possible to prevent an occurrence of the conventional problem in which clearing of the retained status makes it difficult for a higher-level control circuit (control module) such as the television microcomputer 41 to perform status-based operation control.

Although the present invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

For example, In the abovementioned embodiment, the reset threshold value is set to 2.7 V that is equal to the minimum voltage value in the range of operation guaranteeing voltage values for the power supply control circuit 34. Alternatively, as the reset threshold value, it is also possible to set an arbitrary voltage value (e.g., 2.8 V) that slightly exceeds the minimum voltage value of 2.7 V or that is slightly smaller than (e.g., 2.6 V) the minimum voltage value of 2.7 V. That is, it is possible set an arbitrary voltage value within a range of few hundred mV on either side of the minimum voltage value of 2.7 V.

Apart from that, as the reset threshold value during the initial state, a value can be set that is different than the reset threshold value during the standby state. For example, if the reset threshold value during the standby state is set to 2.7 V that is equal to the minimum voltage value in the range of operation guaranteeing voltage values for the power supply control circuit 34, then the reset threshold value during the initial state can be set to a value smaller than 2.7 V. Thus, the reset threshold value during the initial state can be set to 1.5 V that is the operation voltage value of the internal circuits of the power supply control circuit 34 as illustrated in case in FIG. 3A.

Besides, in the abovementioned embodiment, the recharge threshold value is set to 2.8 V that slightly exceeds the minimum voltage value of 2.7 V in the range of operation guaranteeing voltage values for the power supply control circuit 34. Alternatively, the recharge threshold value can be set to a value smaller than the minimum voltage value of 2.7 V.

Meanwhile, in the abovementioned embodiment, the power supply control circuit 34, the control signal receiving module 35, and the timer 36 are disposed independent of each other. Alternatively, for example, the power supply control circuit 34, the control signal receiving module 35, and the timer 36 can be integrated into a signal LSI circuit.

Moreover, in the abovementioned embodiment, the description is given with reference to a television receiver as an electronic device comprising a power supply control circuit. Alternatively, for example, the description can also be applied to another electronic device such as a picture recorder or a digital versatile disk (DVD) player.

The electronic device such as the television receiver as well as the configuration and the functional configuration of the power supply control circuit according to the abovementioned embodiment is only exemplary. The present invention is not limited to that description.

According to an aspect of the present invention, the reset operation is performed with respect to a power supply control module (power supply control circuit) only if the voltage supplied thereto as a result of connecting a switch module to a main power supply in the fully discharge state of a storage battery or as a result of disconnecting the switch module from the main power supply so that the storage battery falls in the fully discharge state is outside a range of operation guaranteeing voltage values. Hence, as long as the voltage supplied to the power supply control module is within the range of operation guaranteeing voltage values, the reset operation is not performed with respect to the power supply controller irrespective of whether the switch module is turned ON. That makes it possible to retain the status of the power supply control module on a constant basis. For that reason, it becomes possible to prevent an occurrence of the conventional inconveniences in which clearing of the retained status makes it difficult for a higher-level control module such as a microcomputer to perform status-based operation control.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A power supply control module comprising:
a memory module configured to retain a status that represents state information of the power supply control module;
a power supply controller configured to perform supply/cutoff control of a voltage from a main power supply to a load via a power supply circuit by performing ON/OFF control of a switch module that is disposed in between the main power supply and the power supply circuit;
a voltage determination module configured to determine whether, during a standby state operating on a voltage supplied from a charge accumulating module, a value of the voltage supplied from the charge accumulating module is equal to or smaller than a reset threshold value set in advance; and
a reset execution module configured to perform a reset execution operation for clearing the status retained in the memory module, if the voltage determination module determines that the value of the voltage is equal to or smaller than the reset threshold value.

2. The power supply control module of claim 1, wherein
if the switch module is connected to the main power supply in a fully discharge state of the charge accumulating module, the voltage determination module determines whether a value of voltage supplied to self is equal to or greater than the reset threshold value, and
if the voltage determination module determines that the value of the voltage is equal to or greater than the reset threshold value, the reset execution module performs the reset execution operation.

3. The power supply control module of claim 1, wherein the reset threshold value is substantially equal to a minimum voltage value in a range of operation guaranteeing voltage values for the power supply control module.

4. An electronic device comprising a power supply control module, wherein the power supply control module comprising:
a memory module configured to retain a status that represents state information of the power supply control module;
a power supply controller configured to perform supply/cutoff control of a voltage from a main power supply to a load via a power supply circuit by performing ON/OFF control of a switch module that is disposed in between the main power supply and the power supply circuit;
a voltage determination module configured to determine whether, during a standby state operating on a voltage supplied from a charge accumulating module, a value of the voltage supplied from the charge accumulating module is equal to or smaller than a reset threshold value set in advance; and
a reset execution module configured to perform a reset execution operation for clearing the status retained in the memory module, if the voltage determination module determines that the value of the voltage is equal to or smaller than the reset threshold value.

5. The electronic device of claim 4, wherein
if the switch module is connected to the main power supply in a fully discharge state of the charge accumulating module, the voltage determination module determines whether a value of voltage supplied to self is equal to or greater than the reset threshold value, and
if the voltage determination module determines that the value of the voltage is equal to or greater than the reset threshold value, the reset execution module performs the reset execution operation.

6. A reset control method performed in a power supply control module configured to perform supply/cutoff control of a voltage from a main power supply to a load via a power supply circuit by performing ON/OFF control of a switch module that is disposed in between the main wm supply and the power supply circuit, the reset control method comprising:
first-determining, by a voltage determination module, that includes determining whether, during a standby state operating on a voltage supplied from a charge accumulating module, a value of the voltage supplied from the charge accumulating module is equal to or smaller than a reset threshold value set in advance; and
first-reset-controlling, by a reset execution module, that includes performing a reset execution operation for clearing the status retained in a memory module, if the value of the voltage is determined to be equal to or smaller than toe reset threshold value at the first-determining.

7. The reset control method of claim 6, further comprising:
second-determining, by the voltage determination module, that includes determining whether, if the switch module is connected to the main power supply in a fully discharge state of the charge accumulating module, a value of voltage supplied to the voltage determination module is equal to or greater than the reset threshold value; and
second-reset-controlling, by the reset execution module, that includes performing the reset execution operation if the value of the voltage is determined to be equal to or greater than the reset threshold value at the second-determining.
